(19) United States
(12) Patent Application Publication
(10) Pub. No.: US 2007/0198423 A1
(43) Pub. Date: Aug. 23, 2007

(54) METHOD,SYSTEM AND COMPUTER PROGRAM FOR METERING USAGE OF MULTIPLE INSTANCES OF SOFTWARE COMPONENTS

(76) Inventors: Giancarlo Carbone, Rome (IT); Fabio Cerri, Rome (IT); Marco Mechelli, Rome (IT); Antonio Perrone, Roma (IT)

Correspondence Address: IBM CORPORATION;INTELLECTUAL PROPERTY LAW, 11400 BURNET ROAD, AUSTIN, TX, 78758, US

(21) Appl. No.: 11/676,524

(22) Filed: Feb. 20, 2007

(30) Foreign Application Priority Data
Feb. 20, 2006 (EP) 06110140.8

(51) Int. Cl. H04L 9/00

(52) U.S. Cl. 705/52

(57) ABSTRACT

A solution (500) for metering the usage of software products is proposed. For this purpose, a software catalogue (520c) is used to associate each software product to be metered with an installation signature and a usage signature. In the proposed solution, a scope (A2-A5) is determined for each installation item and usage item (available in the system), which match an installation signature and a usage signature, respectively; the scope represents a property specific of the context of an instance of the corresponding software product. The scope of each usage item (such as a path for an executable module) is then best matched (A6-A7) with one of the scopes of the installation items of the corresponding software product (another path for a different file); for example, this process is based on the number of common levels between the two paths. In this way, the scopes associated with the usage items identifying the running of the same software product may be used to discriminate (A13-A15) different instances of this software product.

### FIELD OF THE INVENTION

The present invention relates to the information technology field. More specifically, the invention relates to the metering of the usage of software products in a data processing system.

### BACKGROUND ART

Metering the usage of software products in a data processing system is of the utmost importance in several management infrastructures. A typical example consists of a license management application, which is used to collect information about known software products running on the system (for example, for charge-back accounting). A commercial license management application available on the market is the “IBM Tivoli License Manager (ITLM)” by IBM Corporation.

Typically, the license management applications known in the art detect the software products that are running on the system (for example, periodically retrieving a list of active processes); those software products are then identified by means of a software catalogue, which includes a predefined signature for each software product to be metered. For example, the signature of a generic software product defines an executable module (which running indicates the usage of the software product). In order to increase the accuracy of the identification, the executable modules are generally specified by multiple attributes (such as their name and size).

As a further improvement, it has also been proposed to use two different signatures for each software product; particularly, an installation signature is used to identify the installation of the software product, whereas a usage signature is used to identify its running. The installation signatures are defined by complex conditions, which allow identifying each software product uniquely (for example, according to the presence of specific files and/or configuration settings); conversely, each usage signature may be associated with different software products (such as multiple versions or service levels thereof). The license management application off-line identifies all the software products that are installed on the system; this operation results in the generation of a reduced software catalogue, which includes the usage signatures of the installed software products only (thereby resolving possible ambiguities). The reduced software catalogue is then used at runtime to identify the software products running on the system. In this way, it is possible to discriminate the usage of different software products that share the same usage signature.

However, a problem arises when multiple instances of a software product are available on the system. For example, an instance of the software product may be installed for serving a group of users and a different instance of the same software product may be installed for serving another group of users. A further example is when the software product consists of a software component to be used in more complex software applications; in this case, the same software component may be included in two or more different software applications.

The license management applications known in the art can only determine the number of available instances of the software product; however, they are completely unable to discriminate their usage. Indeed, the different instances of the software product share the same (installation and usage) signature; therefore, it is not possible to identify which instance of the software product is actually running.

The problem is particular acute when different conditions of use apply to specific exploitation of the same software product. For example, the conditions of use of the software product may change according to its actual usage (with a corresponding licensing fee that may increase with the number of users). Likewise, the conditions of use of the software component may depend on the software application that embeds it (with its usage that may be free of charge in specific contexts and subjected to licensing fees increasing with the complexity of the software applications in other contexts).

### SUMMARY OF THE INVENTION

The present invention provides a solution as set out in the independent claims. Advantageous embodiments of the invention are described in the dependent claims.

In principle, the solution according to an embodiment of the present invention is based on the idea of associating a scope to each instance of the software products.

Particularly, an aspect of the invention proposes a method for metering usage of software products in a data processing system; one ore more instances of each software product are available on the system in a corresponding context. The method starts with the step of providing a software catalogue, which associates each software product with a usage signature; the usage signature is indicative of the usage of any instances of the software product. A scope is then associated with each usage item matching a usage signature; the scope is indicative of a corresponding instance of the software product associated with the usage signature. The method continues by detecting the usage items running on the system. The instance associated with each running usage item can now be identified (individually) according to the corresponding scope.

In an embodiment of the invention, the software catalogue further associates each software product with a corresponding installation signature. In this case, the scope is determined for each installation item that matches an installation signature (according to the context of the installation item); an auxiliary scope of each usage item is likewise determined according to its context. The auxiliary scope of each usage item is then best matched with one of the scopes of the installation items of the corresponding software product.

As a further improvement, the scopes of the installation items are consolidated according to a set of predefined rules.

When the installation items consist of files (and the corresponding scopes are their paths), this result may be based on an inclusion relationship of the paths.

A suggested choice for best matching the scopes is of exploiting corresponding scores.

Assuming that the usage items consist of files as well, this result may be achieved by comparing the path of the usage item with the path of each installation item of the corresponding software product.

Preferably, the operation is based on the number of levels that are common between the two paths.

Typically, the instance associated with each running usage item is identified by comparing the corresponding scope with a set of predefined rules.

Another aspect of the invention proposes a computer program for performing the method.

A further aspect of the invention proposes a corresponding system.

### REFERENCE TO THE DRAWINGS

The invention itself, as well as further features and the advantages thereof, will be best understood with reference to the following detailed description, given purely by way of a non-restrictive indication, to be read in conjunction with the accompanying drawings, in which:

FIG. 1a is a schematic block diagram of a data processing system in which the solution according to an embodiment of the invention is applicable;

FIG. 1b shows the functional blocks of an exemplary computer of the system;

FIG. 2 is a class diagram modeling an implementation of the solution according to an embodiment of the invention;

FIG. 3 illustrates an exemplary application of the solution according to an embodiment of the invention;

FIG. 4 is a decision tree describing an implementation of the solution according to an embodiment of the invention; and

FIG. 5 is a collaboration diagram representing the roles of different software modules implementing the solution according to an embodiment of the invention.

### DETAILED DESCRIPTION

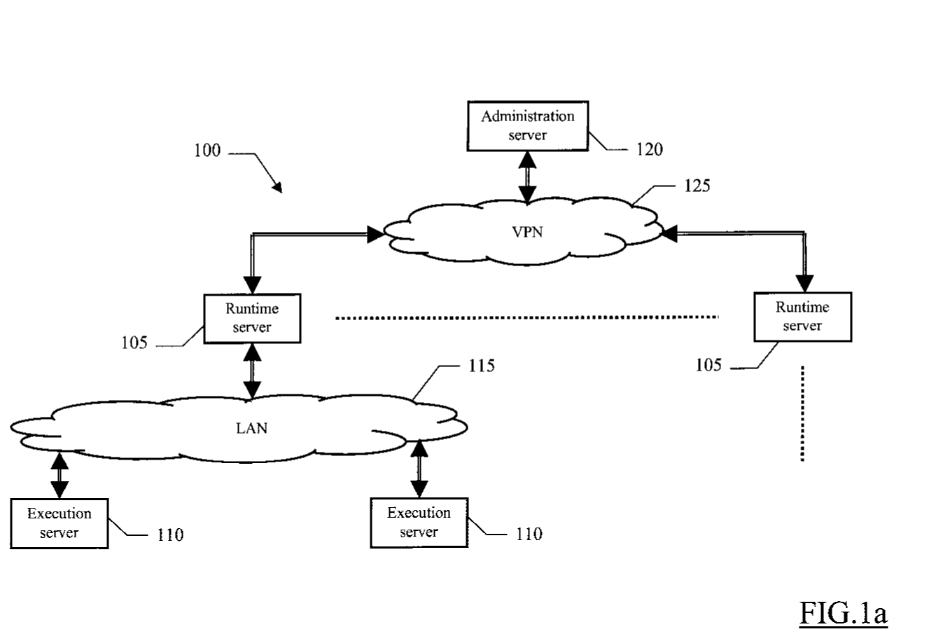

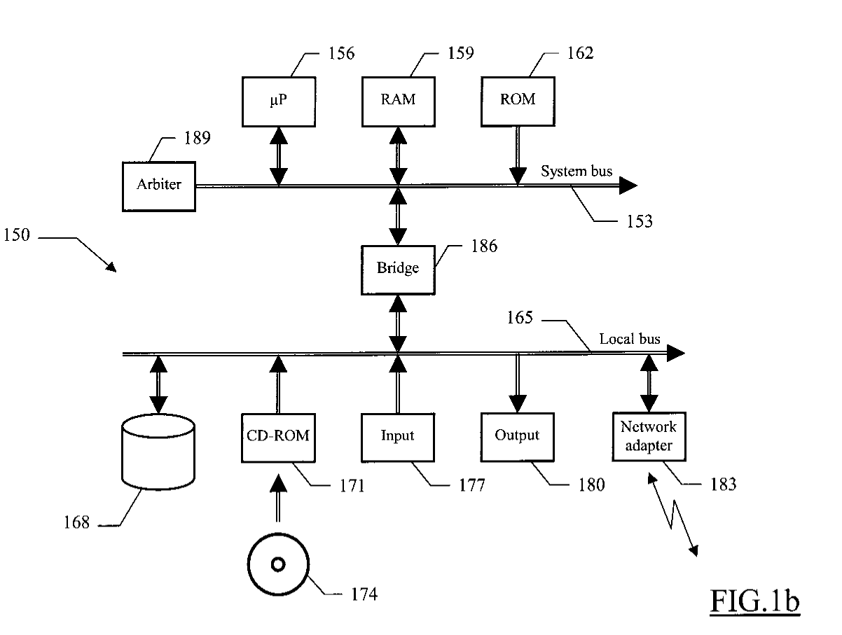

With reference in particular to FIG. 1a, a data processing system 100 with distributed architecture is depicted. The system 100 implements a license management infrastructure (for example, based on the above-mentioned “ITLM”), which allows metering the usage of selected software products. The software products may be either (complete) software applications or software components, intended to be used in different software applications.

The system 100 includes one or more independent organizations (only one shown in the figure), which are completely separate and distinct from each other. Within the organization, different divisions are defined. Each division is controlled by a runtime server 105, which collects information about the usage of assigned software products on a set of corresponding execution servers (or nodes) 110; for this purpose, the runtime server 105 and all the execution servers 110 of the division communicate through a network 115 (for example, a LAN). The different runtime servers 105 report to a single administration server 120, which implements a central control point for inventory and procurement of the whole organization; the runtime servers 105 and the administration server 120 are connected to a different network 125 (for example, a Virtual Private Network or VPN based on the Internet).

Considering now FIG. 1b, a generic computer of the above-described system (runtime server, execution server or administration server) is denoted with 150. The computer 150 is formed by several units that are connected in parallel to a system bus 153 (with a structure that is suitably scaled according to the actual function of the computer 150 in the system). In detail, one or more microprocessors (μP) 156 control operation of the computer 150; a RAM 159 is directly used as a working memory by the microprocessors 156, and a ROM 162 stores basic code for a bootstrap of the computer 150. Several peripheral units are clustered around a local bus 165 (by means of respective interfaces). Particularly, a mass storage consists of one or more hard-disks 168 and a drive 171 for reading CD-ROMs 174. Moreover, the computer 150 includes input units 177 (for example, a keyboard and a mouse), and output units 180 (for example, a monitor and a printer). An adapter 183 is used to plug the computer 150 into the system. A bridge unit 186 interfaces the system bus 153 with the local bus 165. Each microprocessor 156 and the bridge unit 186 can operate as master agents requesting an access to the system bus 153 for transmitting information. An arbiter 189 manages the granting of the access with mutual exclusion to the system bus 153.

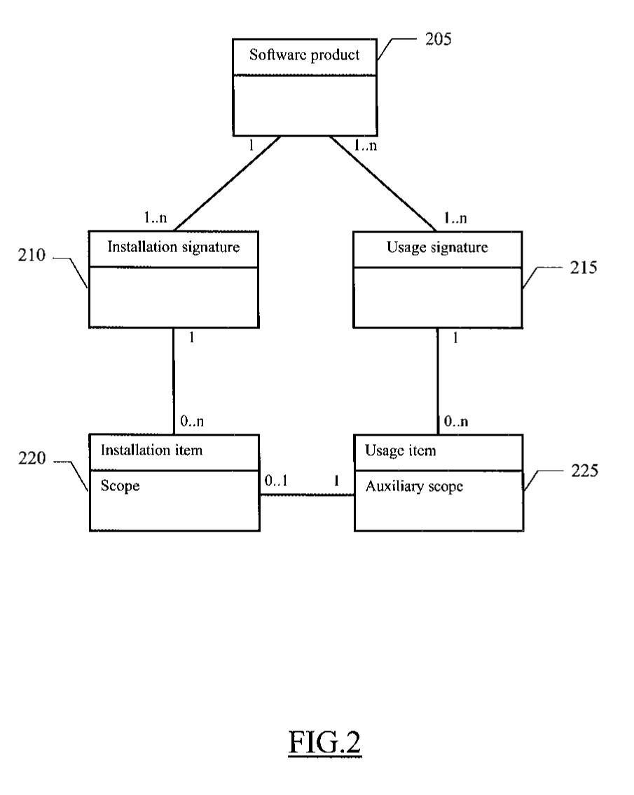

Moving to FIG. 2, the process of metering the usage of the desired software products on each execution server is based on corresponding signatures. More specifically, each software product (class 205) is identified by one or more installation signatures (class 210) and one or more usage signatures (class 215).

The installation signatures are used to identify the software products that are installed on the execution server. For example, the installation signature can consist of a file, such as an executable module, a dynamic library, a help file, or a database (generally defined by multiple attributes, such as its name, size and checksum). Another example of installation signature is a configuration parameter, such as the value of a specific registry key. A more complex example of installation signature is an extended signature, which consists of a logical expression based on multiple conditions (such as of the above-mentioned type). In any case, each installation signature uniquely identifies a single software product, when a corresponding installation item of the software product available on the execution server (class 220) matches the installation signature 210; however, if more instances of the same software product are present on the execution server, the installation items 220 of all of them will match the same installation signature 210.

On the other hand, the usage signatures are intended to identify the software products that are running on the execution server. For example, the usage signature can consist of an executable module (generally simply defined by its name). Another example of usage signature is an instrumentation signature, which is returned by the software product itself (specifically adapted for this purpose). As a further example, the usage signature can be an application name provided by a web server (such as the “WebSphere” by IBM Corporation). It should be noted that each usage signature may identify multiple software products (such as different versions or service levels of the same software product), since a corresponding usage item of those software products available on the execution server (class 225) generally matches the same usage signature 215. Moreover, as in the preceding case, the usage items 225 of multiple instances of the same software product will match the same usage signature 215 as well.

As described in detail in the following, in the solution according to an embodiment of the invention each usage item 225 available on the execution server is associated with a scope. The scope represents a property, which is specific to the context (or installation environment) of the instance of the software product that is identified by the usage item 225. The nature of the scope depends on the technology that is used to define the (installation and usage) signatures. For example, the scope may consist of a path for a file stored in a file system of the execution server, a directory for a configuration parameter of a system registry, the name of a web server for a web application (such as based on the J2EE technology), and the like. Those values may be detected by scanning the mass storage of the execution server or by reading its system registry; alternatively, they may be extracted from a deployment descriptor of the web application, or they may be returned by an engine used to evaluate the extended signatures or by the software products directly when they are suitably instrumented. In any case, it is emphasized that the scope may only be determined at runtime by analyzing the instances of the software product that are actually available on the execution server; in other words, the possible values of the scopes are unknown a priori. Therefore, the scopes clearly differ from the (installation and usage) signatures, which are always predefined.

The scopes associated with the usage items 225 of the instances of the software products running on the execution server may then be used to identify them uniquely (even if the usage items 225 match the same usage signature 215). Particularly, this information allows discriminating multiple instances of the same software product (such as when two or more instances of the software product are installed for serving different groups of users, or when the same software component is used by two or more software applications). This is very important when different conditions of use apply to specific exploitation of the same software product (such as depending on its actual usage, or on the software application embedding it). Therefore, the proposed solution allows applying the correct licensing fees to the different instances of the software products that are running on the execution server.

More in detail, the scope is determined for each installation item 220 available on the execution server (matching the installation signature 210 of the corresponding software product); for this purpose, the scope is defined according to the context of the installation item 220. An auxiliary scope is likewise determined for each usage item 225 matching the usage signature 215 of the same software product (according to its context). Each usage item 215 is then associated with the scope of one of the corresponding installation items 220, which best matches its auxiliary scope.

For this purpose, a score is assigned to the scope of each installation item 220; the score represents the likelihood that the installation item 220 identifies the installation of the same instance of the software product, which usage is identified by the usage item 225. The scope with the highest score is then selected as the best match. Conversely, when two or more scopes have the maximum score, an ambiguity is found. In this case, it is not possible to select the best match (and the software product identified by the usage item 225 will be metered generically and not for its instances).

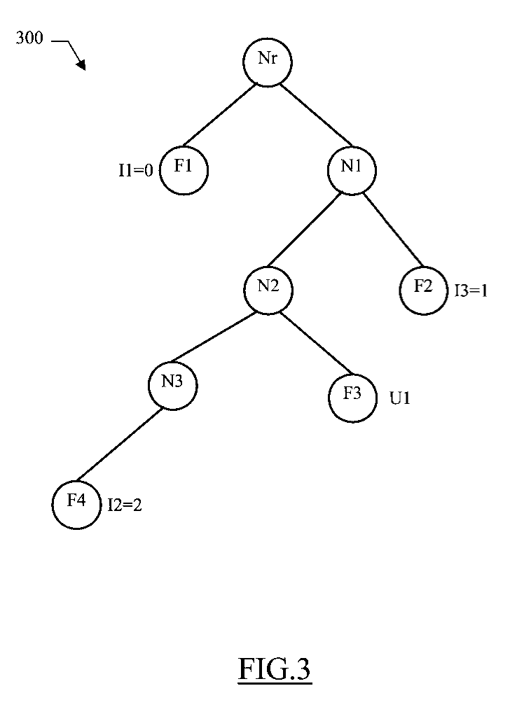

An exemplary application of the above-mentioned best match algorithm to (installation and usage) signatures based on files is illustrated in FIG. 3. Typically, the execution server implements a file system with a hierarchical structure. Particularly, the file system is organized as a tree 300, starting from a root directory Nr defining a (physical or logical) device. Each intermediate node N1,N2,N3 (having one or more child nodes dependent thereon) defines a sub-directory. Leaf nodes F1,F2,F3,F4 having no child nodes dependent thereon are files (or empty sub-directories). The position wherein each file F1-F4 is stored can be accessed by means of a corresponding path starting from the root directory Nr and reaching the file F1-F4 through the interposed sub-directories N1-N3 (if any). For example, a usage item (file) U1 is accessed by the path “Nr/N1/N2/”; likewise, installation items (files) I1, I2 and I3 are accessed by the paths “Nr/”, “Nr/N1/N2/N3” and “Nr/N1/”, respectively.

The scopes of the (installation and usage) files U1, I1-I3 are then defined by the above-mentioned paths. In this case, the score of the scope of each installation file I1-I3 is given by the number of common (intermediate) levels of nodes between its path and the one of the auxiliary scope of the usage file U1. In the example at issue, the scores of the installation files I1, I2 and I3 will be 0, 2 and 1, respectively. Therefore, the scope of the installation file I2 (i.e., “Nr/N1/N2/N3”) is selected as the best match to be associated with the usage item U1.

However, a problem may arise when different installation items on the execution server represent the same instance of a software product. A typical example is when the installation item used to identify the software product is upgraded (with the original version that is maintained for its possible restoring); another example is the creation of a backup copy of the installation item. In those cases, both the real installation item of the software product and its previous version will be available on the execution server (even if a single instance of the software product is actually installed). The same problem is also experienced when the installation signatures are defined by multiple conditions that may be satisfied alternatively (logic OR). As a result, it is possible that two or more installation items available on the execution server represent a single instance of a software product. In order to solve this problem, the installation items (with their scopes) are preferably consolidated to remove any duplication.

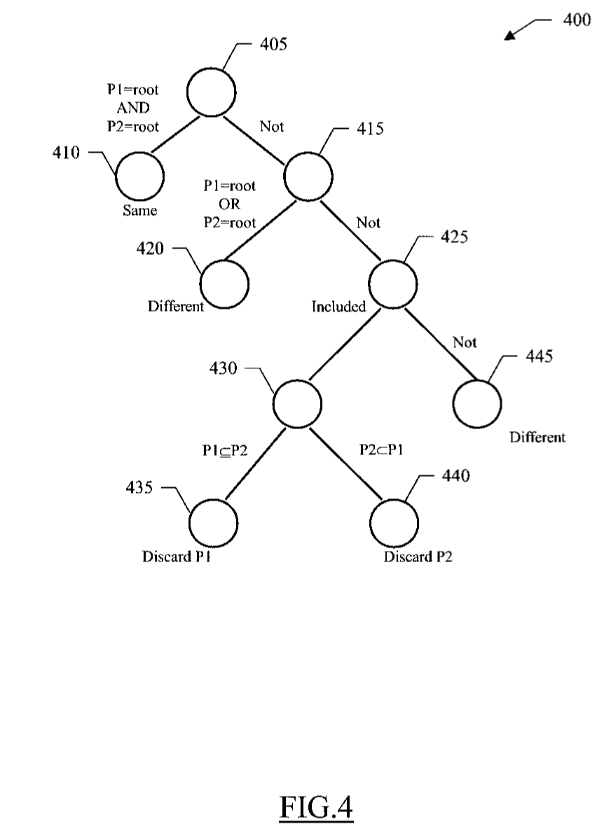

An exemplary consolidation algorithm for use in the case of installation files is illustrated in FIG. 4 by means of a decision tree 400. In this case, the consolidation algorithm is based on an inclusion relationship between the paths (i.e., the scopes) of each pair of installation files.

In detail, the decision tree 400 includes a root node 405 discriminating the type of paths of the installation files (generically denoted with P1 and P2). If both the paths P1 and P2 consist of root directories, the process immediately ends at node 410, wherein the two installation files are considered representing the same instance of the software product (so that one of them is discarded).

Conversely, the decision flow passes to node 415. If one of the paths P1 or P2 consists of a root directory (but not both of them), the process likewise ends at node 420, wherein the two installation files are considered representing different instances of the software product (to be maintained); this choice is motivated by the fact that the inclusion of one path within the root directory is not significant (because the root directory includes all the other paths for its nature). In the opposite case, the method verifies at node 425 whether the paths P1 and P2 are one included within the other. If so, the process descends into node 430. When the path P1 is included within the path P2 (or they are equal), the installation item associated with the (inner) path P1 is discarded at node 435; conversely, the installation item associated with the path P2 is discarded at node 440. Referring back to node 425, when the paths P1 and P2 are not included within each other the process ends at node 445, wherein the two installation files are considered representing different instances of the software product.

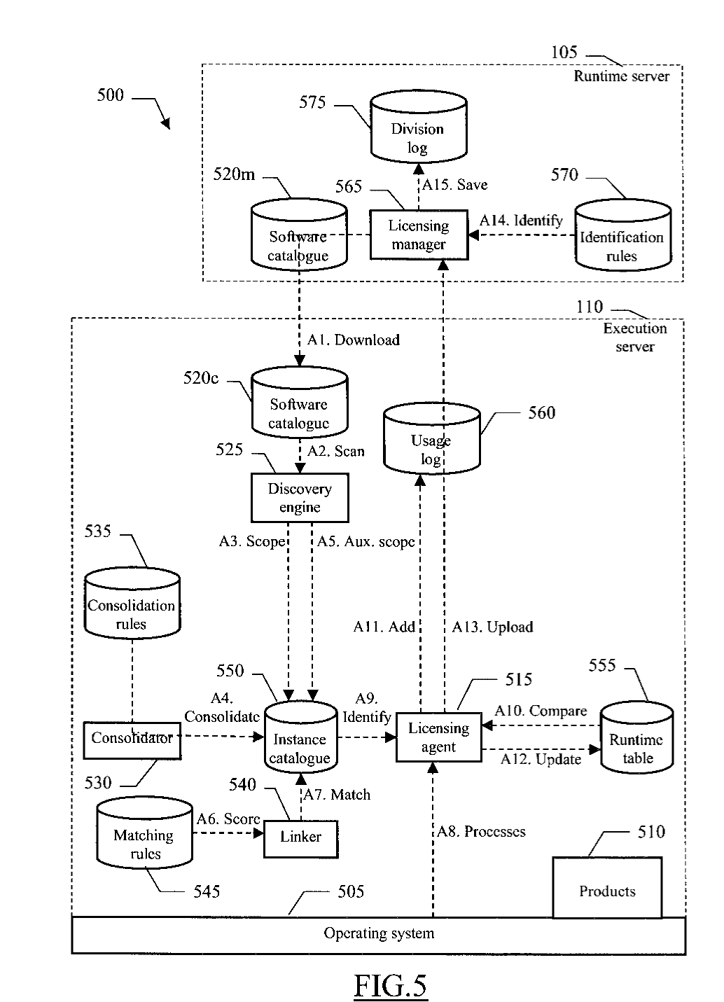

Moving now to FIG. 5, the main software modules that run on the above-described system are denoted as a whole with the reference 500. The information (programs and data) is typically stored on the hard-disk and loaded (at least partially) into the working memory of each computer when the programs are running. The programs are initially installed onto the hard disk, for example, from CD-ROM. Particularly, the figure describes the static structure of the system (by means of the corresponding modules) and its dynamic behavior (by means of a series of exchanged messages).

Considering in particular the execution server 110 of a generic division, an operating system 505 (such as the “zOS” by IBM Corporation) defines its software platform. Multiple software programs 510 are installed on the execution server 110 (on top of the operating system 505).

A licensing agent 515 (continually running in the background) detects the usage of the software products 510 on the execution server 110. The process is based on the content of a local copy of a software catalogue 520c that is downloaded from the runtime server 105, for example, periodically or at any change thereof (action A1). The software catalogue 520c specifies all the known software products to be metered in the organization by means of their installation signatures and usage signatures.

The software catalogue 520c is accessed by a discovery engine 525, such as the “IBM Tivoli Common Inventory Technology (CIT)” service of the “ITLM”. The discovery engine 525 scans the execution server 110, so as to detect all the available installation items that match an installation signature and all the available usage items that match a usage signature, respectively (action A2).

In this phase, the discovery engine 525 also determines the scope of each installation item that was discovered (action A3). A module 530 consolidates the installation items with their scopes, so as to remove any duplication (action A4); for this purpose, the consolidator 530 exploits a set of predefined consolidation rules stored in a corresponding repository 535 (for example, based on the above-described inclusion relationship among the corresponding paths). At the same time, the discovery engine 525 determines the auxiliary scope of each usage item that was discovered (action A5). For each usage item, a linker 540 calculates the scores of the scopes of all the corresponding installation items for the same software product (action A6); the process is based on a set of predefined matching rules that are stored in a corresponding repository 545 (for example, based on the above described number of common levels among the corresponding paths). The linker 540 then associates each usage item with the scope having the highest score (action A7); if this is not possible (because all the scores are zero or two or more scores have the maximum value), the usage item is flagged to indicate that the corresponding software product will be metered generically (and not for its instances). The information so obtained is saved into an instance catalogue 550. The instance catalogue 550 lists all the usage items available on the execution server 110; for each usage item, the instance catalogue 550 specifies the corresponding software product and its scope (if possible).

Periodically (for example, every 1-10 minutes), the licensing agent 515 retrieves a list of processes that are active on the execution server 110 (by means of a corresponding API of the operating system 505). For each process, the licensing agent 515 verifies whether the name of the corresponding executable module (returned from the operating system 505) is included in the instance catalogue 550; when the executable module matches an entry in the instance catalogue 550, the corresponding software product is determined and its instance is identified by the associated scope (action A9). The information so obtained is compared with the content of a runtime table 555, which provides a snapshot of the instances of the software products currently in use on the execution server 110; in this way, it is possible to detect the instances of the software products that have been started or stopped since the last iteration of the operation (action A10). Each detected event is added to a usage log 560, together with a corresponding time-stamp (action A11). At the same time, the runtime table 555 is updated accordingly (action A12).

With a different periodicity (for example, at the end of every day), the licensing agent 515 extracts the information available in the usage log 560; this usage information is then uploaded to the runtime server 105, together with the identifier of the execution server 110 (action A13).

The runtime server 105 includes a licensing manager 565, which receives the usage information from every execution server 110 of the division. The licensing manager 565 identifies each instance of the software products that was started or stopped according to its scope (action A14); for this purpose, the licensing manager 565 exploits a set of predefined identification rules stored in a corresponding repository 570. For example, in the case of a software component the identification rules may be based on the inclusion of the path (i.e., the scope) of each instance of the software component within the path of suitable software applications that may embed the software component. The usage information so completed is saved into a (global) division log 575 (action A15), and transmitted to the administration server (not shown in the figure). Moreover, the licensing manager 565 also downloads a main copy of the software catalogue (denoted with 520m) from the same administration server (for example, periodically or at any change thereof).

Typically, the administration server aggregates the received information into a usage report. The usage report lists the instances of the software products that ran on the execution servers 110 in a predetermined period (such as the last day); for each instance of the software products, the usage report specifies the length of any running period on a different number of execution servers 110. This information may be used to charge a prescribed licensing fee for any usage peak of the instances of the known software products (according to predefined rates varying according to the actual use of the software products).

Naturally, in order to satisfy local and specific requirements, a person skilled in the art may apply to the solution described above many modifications and alterations. Particularly, although the present invention has been described with a certain degree of particularity with reference to preferred embodiment(s) thereof, it should be understood that various omissions, substitutions and changes in the form and details as well as other embodiments are possible; moreover, it is expressly intended that specific elements and/or method steps described in connection with any disclosed embodiment of the invention may be incorporated in any other embodiment as a general matter of design choice.

Particularly, similar considerations apply if the system has a different architecture or includes equivalent units. For example, the execution servers (down to a single one) may be associated with a single runtime server (which receives and processes the usage information at the same time); in any case, nothing prevents the application of the proposed solution to a single computer. Moreover, each computer may have another structure or may include similar elements (such as cache memories temporarily storing the programs or parts thereof to reduce the accesses to the mass memory during execution); in any case, it is possible to replace the computer with any code execution entity (such as a PDA, a mobile phone, and the like).

Moreover, the proposed solution may be used to meter the usage of whatever software products (such as electronic books, multimedia works, or more generally any other digitally encoded manufacture). Likewise, it should be readily apparent that the implementation of the present invention is not limited to any specific licensing application; particularly, the available information may be simply used to verify compliance with applicable conditions of use, or more generally for whatever management purpose. More generally, the solution according to the present invention lends itself to be used in different environments (such as for monitoring applications).

Without departing from the principles of the invention, the usage signatures may be of different type or they may be provided in an equivalent way. Likewise, the above-described scopes are merely illustrative, and they must not be interpreted in a limitative manner. Other techniques may also be used for detecting the software products that are running on the execution server; for example, it is possible to intercept the invocation of any new software product by using a kernel hooking technique.

Similar considerations apply to the installation signatures. In this respect, it is also emphasized that the software catalogue does not necessarily consist of a single file; alternatively, it is possible to provide a file for the installation signatures and another file for the usage signatures, or more generally any other equivalent structure. In any case, nothing prevents the application of the proposed solution in a simple environment supporting a single (usage) signature for each software product (without any best matching process).

In addition, the scopes associated with the installation items may be preprocessed in a different way (for their consolidation), or even directly used as is.

Naturally, different algorithms may be used to compare the paths of the installation files; more generally, the solution according to an embodiment of the present invention may be implemented with different consolidation rules (based on whatever property of the scopes, such as the locations of web servers).

Similar considerations apply when the scopes are best matched with different algorithms (for example, based on fuzzy logic techniques).

In this case as well, it is possible to exploit other algorithms to compare the two paths to be matched (for example, strictly based on an inclusion relationship).

In any case, the same result may be achieved with different matching rules (even based on other properties of the scopes, such as the distance between corresponding locations).

Alternatively, the scopes may be used to identify the instances of the software products in an equivalent way (for example, by means of artificial intelligence techniques). However, in a basic implementation the scopes are simply provided to a system administrator for their manual analysis.

Similar considerations apply if the program (which may be used to implement each embodiment of the invention) is structured in a different way, or if additional modules or functions are provided; likewise, the memory structures may be of other types, or may be replaced with equivalent entities (not necessarily consisting of physical storage media). Moreover, the proposed solution lends itself to be implemented with an equivalent method (having similar or additional steps, even in a different order). In any case, the program may take any form suitable to be used by or in connection with any data processing system, such as external or resident software, firmware, or microcode (either in object code or in source code). Moreover, the program may be provided on any computer-usable medium; the medium can be any element suitable to contain, store, communicate, propagate, or transfer the program. Examples of such medium are fixed disks (where the program can be pre-loaded), removable disks, tapes, cards, wires, fibers, wireless connections, networks, broadcast waves, and the like; for example, the medium may be of the electronic, magnetic, optical, electromagnetic, infrared, or semiconductor type.

In any case, the solution according to the present invention lends itself to be carried out with a hardware structure (for example, integrated in a chip of semiconductor material), or with a combination of software and hardware.

1. A method for metering usage of software products in a data processing system, at least one instance of each software product being available on the system in a corresponding context, the method including the steps of:
providing a software catalogue associating each software product with a usage signature, the usage signature being indicative of the usage of any instances of the software product,
associating a scope with each usage item matching a usage signature, the scope being indicative of a corresponding instance of the software product associated with the usage signature,
detecting the usage items running on the system, and
identifying the instance associated with each running usage item
according to the corresponding scope.

2. The method according to claim 1, wherein the software catalogue further associates each software product with an installation signature, the installation signature being indicative of the installation of any instances of the software product, the step of associating the scope with each usage item including:
determining the scope for each installation item matching an installation signature, the scope being determined according to the context of the installation item,
determining an auxiliary scope of each usage item according to the context of the usage item, and
matching the auxiliary scope of each usage item with one of the scopes of the installation items of the corresponding software product according to a set of predefined matching rules.

3. The method according to claim 2, wherein the step of associating the scope with each usage item further includes:
consolidating the scopes of the installation items according to a set of predefined consolidation rules.

4. The method according to claim 3, wherein each installation item includes an installation file and the corresponding scope includes a path of the installation file, the step of consolidating the scopes of the installation items including:
discarding the scopes according to an inclusion relationship of the paths of the corresponding installation items.

5. The method according to claim 2, wherein the step of matching the auxiliary scope of each usage item includes:
determining a score of the scope of each installation item of the corresponding software product, and
selecting the scope with the highest score.

6. The method according to claim 5, wherein each usage item includes a usage file and the corresponding auxiliary scope includes a path of the usage file, the step of determining the score of the scope of each installation item including:
comparing the path of the usage item with the path of the installation item.

7. The method according to claim 6, wherein the step of comparing the path of the usage item with the path of the installation item includes:
calculating the number of levels being common between the path of the usage item and the path of the installation item.

8. The method according to claim 1, wherein the step of identifying the instance associated with each running usage item includes:
comparing the corresponding scope with a set of predefined identification rules.

9. (canceled)

10. (canceled)

11. A computer program product in a computer-usable medium, the computer program when executed on a data processing system causing the system to perform a method for metering usage of software products in the system, wherein at least one instance of each software product is available on the system in a corresponding context, the method including the steps of:
providing a software catalogue associating each software product with a usage signature, the usage signature being indicative of the usage of any instances of the software product,
associating a scope with each usage item matching a usage signature, the scope being indicative of a corresponding instance of the software product associated with the usage signature,
detecting the usage items running on the system, and
identifying the instance associated with each running usage item according to the corresponding scope.

12. A metering system for metering usage of software products in a data processing system, at least one instance of each software product being available on the system in a corresponding installation context, the metering system including:
a software catalogue associating each software product with a usage signature, the usage signature being indicative of the usage of any instances of the software product,
a discovery engine for associating a scope with each usage item matching a usage signature, the scope being indicative of a corresponding instance of the software product associated with the usage signature, and
an agent for detecting the usage items running on the system and for identifying the instance associated with each running usage item according to the corresponding scope.
